(19) United States
(12) Patent Application Publication
(10) Pub. No.: US 2008/0240093 A1
(43) Pub. Date: Oct. 2, 2008

(54) Stream multiplexer/de-multiplexer

(75) Inventors: Amir Morad, Tel-Aviv (IL); Leonid Yavits, Herzlia (IL); Gedalia Oxman, Tel-Aviv (IL); Michael Khrapkovsky, Herzlia (IL); Ofer Austerlitz, Tel-Mond (IL); Hila Madar, Haifa (IL)

Correspondence Address: Martin D. Moynihan;PRTSI, Inc., P.O. Box 16446, Arlington, VA, 22215, US

(73) Assignee: Horizon Semiconductors Ltd., Herzlia (IL)

(21) Appl. No.: 11/727,719

(22) Filed: Mar. 28, 2007

(51) Int. Cl. H04L 12/56

(52) U.S. Cl. 370/389; 370/412; 370/535

(57) ABSTRACT

Apparatus for performing multiplexing and de-multiplexing of packetized digital data streams, including receivers for receiving data packets from packetized digital data streams, validating the packets, and transmitting only valid packets, PID filters for filtering packets according to a Packet ID included in the packets, the filters receiving valid packets from the receivers, and associating a store-or-drop value with each valid packet, input FIFO buffers for receiving valid packets from the receivers, receiving the store-or-drop value from the PID filters, and storing data based, at least in part, on the store-or-drop value, an input/output unit for transmitting the stored data from the input FIFO buffers to an external memory and reading data from the external memory, output FIFO buffers for receiving data from the input/output unit and storing the data, and transmitters for reading digital data packets from the output FIFO buffers and transmitting the packets as a packetized digital data stream, thereby de-multiplexing the packetized digital data streams and multiplexing the packetized digital data streams. Related apparatus and methods are also described.

### FIELD OF THE INVENTION

The present invention relates to a stream multiplexer/de-multiplexer for communication systems, and in particular to System on a Chip (SoC) devices which reside in digital communication systems, such as, by way of non-limiting examples, set top boxes for cable, for satellite, for IPTV (Internet Protocol TV), for DTVs (Digital TVs), and home gateways, the devices being configured to receive and transmit multiplexed video, audio, and data media streams.

### BACKGROUND OF THE INVENTION

The devices mentioned above, collectively termed herein set top boxes (STBs), are used to receive transport and program streams which include compressed and uncompressed video, audio, still image, and data channels. The streams are transmitted through cable, satellite, terrestrial, and IPTV links, or through a home network. The devices demodulate, decrypt, de-multiplex and decode the transmitted streams, and, by way of a non-limiting, typical example, provide output for television display. Additionally, the devices may store the streams in storage devices, such as, by way of a non-limiting example, a hard disk. In addition, the devices may multiplex uncompressed and/or compressed audio, video and data packets, and transmit such a multiplexed stream to an additional storage device, to another STB, to a home network, and the like.

Some digital television sets include electronic components similar to the STBs, and are able to perform tasks performed by a basic set-top box, such as de-multiplexing, decryption and decoding of one or two channels of a multiplexed compressed stream.

The digital television sets and STBs may receive a multi-channel transport/program stream containing video, audio and data packets, encoded in accordance with a certain encoding standard such as, by way of a non-limiting example, MPEG-2 or MPEG-4 AVC standard. The data packets may represent e-mail, graphics, gaming, an Electronic Program Guide, Internet information, etc.

A program stream protocol and a transport stream protocol are specified in MPEG-2 Part1, Systems (ISO/IEC standard 13818-1). Program streams and transport streams enable multiplexing and synchronization of digital video and audio streams. Transport streams offer methods for error correction, used for transmission over unreliable media. The transport stream protocol is used in broadcast applications such as DVB (Digital Video Broadcasting) and ATSC (Advanced Television Systems Committee). The program stream is designed for more reliable media such as DVD and hard-disks.

The transport stream and program stream are generally composed of various digital data packet header elements, such as, by way of non-limiting examples, PID (Packet IDentification) and PCR (Program Clock Reference), and various digital data packet payloads, such as, by way of a non-limiting example, video, audio, PAT (Program Association Table), PMT (Program Mapping Table), and null packets.

A packet is a basic unit of data in a transport stream. In one standard, by way of a non-limiting example, the packet consists of a sync byte, whose value is 0x47, followed by three one-bit flags, a 13-bit PID (Packet Identifier), and a 4-bit continuity counter. Additional optional fields in a transport packet may follow, and are signaled in an optional adaptation field. The rest of the packet consists of payload. Packets are often 188 bytes in length, although some transport streams consist of 204-byte packets comprising 188 bytes as described above, with additional 16 bytes of Reed-Solomon error correction data, and some transport streams consist of packets of other sizes.

The transport stream generally includes more than one elementary stream. Each elementary stream in the transport stream is typically identified by a 13-bit PID. A de-multiplexer extracts the elementary streams from the transport stream in part by extracting packets identified by the PID. Generally, time-division multiplexing is used to determine how often a particular PID appears in the transport stream.

The transport stream is comprised of programs, which are groups of one or more PIDs which are related to each other. For example, a transport stream used in digital television might contain three programs, representing three television channels. Each television channel, by way of a non-limiting example, consists of one video elementary stream, one or two audio elementary streams, and possibly other metadata on other elementary streams. A receiver wishing to tune to a particular television channel has to decode the payload of the packets associated with the television channel. The receiver can ignore the contents of all other packets.

Some of the terms which were used above will now be explained.

The PAT is broadcast on an elementary stream having a PID which is specified by a broadcast protocol. The PAT lists all programs in the transport stream, and a PID of the elementary stream on which a PMT for the program can be found.

PMTs contain information about which elementary streams, having which PIDs, comprise which programs. Each program has a PMT, broadcast on a separate PID. PMTs also provide metadata about constituent elementary streams. By way of a non-limiting example, if a program contains an MPEG-2 video stream, the PMT will list the PID of the MPEG-2 video stream, identify the elementary stream as a video stream, and specify which type of video encoding is used for the video. The PMT may also contain additional descriptors providing data about the constituent elementary streams.

To assist a decoder in presenting programs on time, at the right speed, and synchronize the elementary streams to each other, a program periodically provides a PCR, on one of the PIDs of the program.

Some transmission protocols, such as those in ATSC and DVB, impose strict constant bit-rate requirements on the transport stream. In order to ensure that the transport stream maintains a constant bit-rate, a multiplexer may need to insert some additional packets, termed null packets. PID 0x1FFF is typically reserved for this purpose. A payload of null packets may contain any data at all, and the payload of null packets may not contain data, and the receiver is expected to ignore the contents of the null packets.

The following reference is believed to represent the state of the art: U.S. patent application Ser. No. 11/603,199 of Morad et al.

The disclosures of all references mentioned above and throughout the present specification, as well as the disclosures of all references mentioned in those references, are hereby incorporated herein by reference.

### SUMMARY OF THE INVENTION

The present invention seeks to provide an improved stream multiplexer/de-multiplexer.

According to one aspect of the present invention there is provided apparatus for performing multiplexing and de-multiplexing of packetized digital data streams, including one or more receivers operative to receive data packets from packetized digital data streams, validate the data packets, and transmit only valid data packets, one or more PID filters operative to filter packets of the digital data streams according to a Packet ID number included in the packets, the PID filters operative to receive valid data packets from the one or more receivers, and to associate a store-or-drop value with each valid data packet, one or more input First In First Out (FIFO) buffers operative to receive valid data packets from the one or more receivers, to receive the store-or-drop value from the PID filters, and to store digital data based, at least in part, on the store-or-drop value, an input/output unit operative to transmit the stored digital data from the one or more input FIFO buffers to an external memory and to read digital data from the external memory, one or more output FIFO buffers operative to receive digital data from the input/output unit and store the digital data, and one or more transmitters operative to read digital data packets from the output FIFO buffers and to transmit the digital data packets as a packetized digital data stream, thereby de-multiplexing the packetized digital data streams and multiplexing the packetized digital data streams.

According to another aspect of the present invention there is provided apparatus for filtering digital data packets of a digital data stream including digital data packets with Packet IDs (PIDS), including an input unit for receiving a digital data packet, a PID reading unit for reading a PID included in the digital data packet, the PID being included of N bits, a comparator for comparing M most-significant bits of the PID, where M<N, to M most-significant bits of a reference number, thereby producing a result, and an output unit for sending an output based, at least partly, on the result.

According to yet another aspect of the present invention there is provided, for a digital data stream including digital data packets with Packet IDs (PIDS), a method for filtering the digital data packets, including, for each packet reading the PID included in the digital data packet, the PID being included of N bits, comparing M most-significant bits of the PID, where M<N, to M most-significant bits of a reference number, thereby producing a result, and sending an output based, at least partly, on the result.

According to another aspect of the present invention there is provided a microcontroller operative to perform at least one of the following as a single instruction: a concatenate-and-accumulate instruction including concatenating a value stored in a first general purpose register (GPR) to a value stored in a second GPR, and adding a result of the concatenating to a value in an accumulator, a bit-reverse instruction including reversing a bit order of a lower N bits of a value stored in a first GPR and storing a result of the bit-reverse instruction in a second GPR, a get-bits instruction including reading an M bit value from an address in a buffer external to the microcontroller, the address being included in the get-bits instruction, and storing the M bit value in a GPR, a put-bits instruction including reading an M bit value from a GPR, and writing the M bit value in an address in a buffer external to the microcontroller, the address being included in the put-bits instruction, a median instruction including computing a median value of more than one general purpose register, and storing the median value in a general purpose register, a controller instruction for controlling dedicated hardware units external to the microcontroller, the address of which, and the digital control signals to be sent, are included in fields included in the controller instruction, a swap instruction for swapping locations of a number of bits of a general purpose register and storing the result in a general purpose register, a load-filter-store instruction for loading more than one value from more than one different memory addresses, performing a linear filtering operation, and storing more than one result into more than one different memory addresses, a clip-N-K instruction for clipping a value included in specific bits in a general purpose register into a range of integers from N through K, where N and K are integers, and storing a result of the clipping in a general purpose register, and a compare-PID instruction for simultaneously comparing a value to more than one other values.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram of a stream multiplexer/de-multiplexer constructed and operative in accordance with a preferred embodiment of the present invention;

FIG. 2 is a simplified functional diagram of a Micro Controller Unit (MCU) constructed and operative in accordance with a preferred embodiment of the stream multiplexer/de-multiplexer of FIG. 1;

FIG. 3 is a simplified functional diagram of a Micro Controller Unit (MCU) constructed and operative in accordance with an alternative preferred embodiment of the stream multiplexer/de-multiplexer of FIG. 1; and

FIG. 4 is a simplified functional diagram of a non-limiting example of a practical use for the stream multiplexer/de-multiplexer of FIG. 1

### DESCRIPTION OF PREFERRED EMBODIMENTS

The present embodiments comprise an improved apparatus and methods for multiplexing and de-multiplexing multiple data streams of video, audio, images, data, media, and other digital data streams. The present embodiments offer improvements in PID filtering, improvements in data flow within a stream multiplexer/de-multiplexer, and improvements in a central processor hardware architecture and instruction set, all contributing to a total improvement in throughput of the multiple data streams.

The term “data stream” in all its forms is used throughout the present specification and claims interchangeably with the terms “audio stream”, “video stream”, “media stream”, “image stream”, “digital data stream”, and their corresponding forms.

The term “data packet” in all its forms is used throughout the present specification and claims interchangeably with the term “packet” and its corresponding forms. The term “data packet” is used for a digital data packet comprised in a digital data stream.

The term “mux” in all its forms is used throughout the present specification and claims interchangeably with the term “multiplexer” and its corresponding forms. The term “demux” in all its forms is used throughout the present specification and claims interchangeably with the term “de-multiplexer” and its corresponding forms.

Persons skilled in the art will appreciate that a media stream can be, by way of a non-limiting example, a video channel, a television broadcast channel, a transport channel, a composite of several video streams, a composite of several video and audio streams, a composite of several video streams which depict an object from different angles, a video stream associated with one or more audio streams, a video stream associated with a number of dubbing streams in a number of languages, a subtitle stream, and an Electronic Program Guide (EPG) stream.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

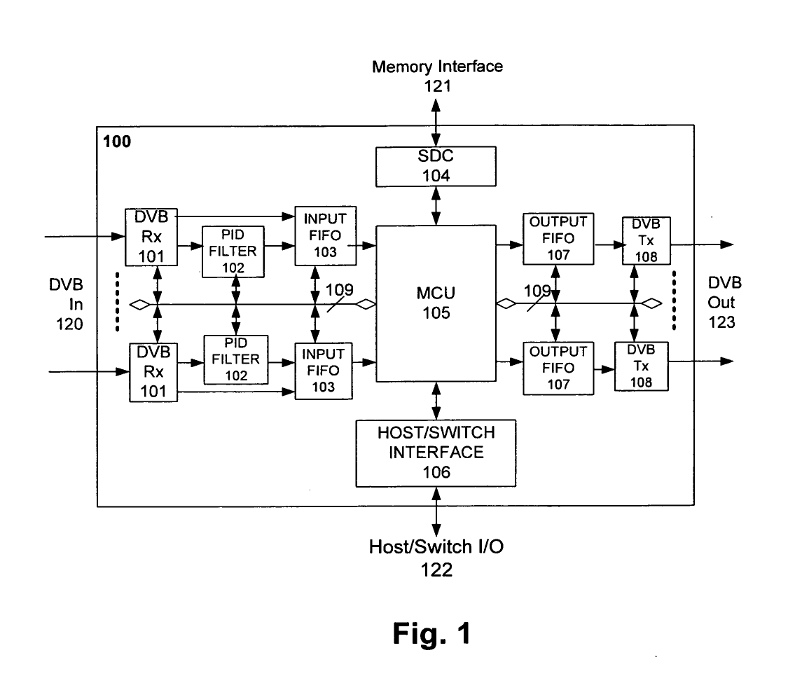

Reference is now made to FIG. 1 which is a simplified block diagram of a stream multiplexer/de-multiplexer 100 constructed and operative in accordance with a preferred embodiment of the present invention.

In a preferred embodiment of the present invention, the stream multiplexer/de-multiplexer 100 is integrated on a single integrated circuit.

The stream multiplexer/de-multiplexer 100 comprises: one or more DVB-in inputs 120, one or more DVB-Rx (Receiver) 101 units, one or more PID filters 102, one or more input FIFO buffers 103, a memory input/output interface 121, a SDRAM Controller (SDC) 104, a Micro Controller Unit (MCU) 105, a Host/Switch interface 106, a Host/Switch input/output 122, one or more output FIFO buffers 107, one or more DVB Transmission (Tx) 108 units, one or more DVB-out outputs 123, and a control bus 109.

The components and interconnections comprised in the stream multiplexer/de-multiplexer 100 will now be described.

In a preferred embodiment of the invention, the stream multiplexer/de-multiplexer 100 receives several multiplexed media streams in parallel, through the DVB-in inputs 120. By way of a non-limiting example, the stream multiplexer/de-multiplexer 100 receives seven distinct input streams. Persons skilled in the art will appreciate that terming the input interface a DVB-in interface in the specification and the drawings does not limit the stream input to a DVB compliant input stream.

Each of the DVB-in inputs 120 is connected to a DVB-Rx 101. The DVB-Rx 101 unit monitors the DVB-in input 120 for incoming packet start codes according to a bus standard and streaming standard appropriate for the input stream. Once a packet is received, the DVB-Rx 101 unit parses the entire packet, and validates consistency of the packet. By way of a non-limiting example, some validation checks include a consistency of the packet header, CRC code, examining the packet size, and so on. It is to be appreciated that the DVB-Rx 101 preferably supports a DVB serial standard and a DVB parallel standard.

In a preferred embodiment of the present invention, the DVB-Rx 101 unit is connected to, and may be programmed and monitored by the MCU 105, through a control bus 109.

The control bus 109 is connected to, and provides programming and monitoring of, various components of the stream multiplexer/de-multiplexer 100, such as the DVB-Rx 101 units, the PID filters 102, the input FIFO buffers 103, the output FIFO buffers 107, and the DVB-Tx 108 units.

The DVB-Rx 101 unit outputs only valid packets to the input FIFO buffers 103 and to the PID filters 102 for further processing. Each one of the DVB-Rx 101 units outputs the valid packets to the input FIFO buffers 103 and to the PID filters 102 which have been configured, through the control bus 109, to work with the specific one of the DVB-Rx 101 units.

Each of the PID filters 102 receives valid packets as described above. The packets belong to a multiplexed data stream, potentially comprised of many individual data streams. A PID comprised in each packet header identifies the individual streams. The PID filter 102 is configured, through the control bus 109, with a PID value or values, and compares the PID in each packet header with the PID value or values. The PID filter 102 associates an indication value with each packet, whether the packet should be stored or dropped, and sends the indication value to a suitable input FIFO buffer 103. Each one of the PID filters 102 outputs the indication value to the input FIFO buffer 103 which has been configured, through the control bus 109, to work with the specific one of the PID filters 102.

Each of the input FIFO buffers 103 receives the valid packets and the indication values described above, and either stores the data packet in the FIFO buffer, or drops the data packet, based on the indication value associated with the data packet.

In a preferred embodiment of the invention, the PID Filter 102 dynamically allocates and shares its resources among the multi-channel DVB-in 120 interfaces. The resources of the PID Filter 102 which can be shared are PID comparators and memory comprised within the PID filter 102 which contains the configured PID values.

In a preferred embodiment of the present invention, each PID filter 102 is connected to each DVB-Rx 101 unit, and to each input FIFO buffer 103, in order to enable sharing the PID filter 102.

It is to be appreciated that several PID filters 102 can be dynamically allocated to the same DVB-Rx 101. Thus a specific DVB-Rx 101 is not limited to using only one PID filter 102. In cases where not all DVB-Rx 101 units are active, or in cases where all of the DVB-Rx 101 units are active, but some of the input streams do not require using the PID filters 102, the PID filters 102 can be used for extending the number of different configured PID values in input streams which do require using PID filters 102.

The input FIFO buffers 103 store validated and filtered packets therein. The MCU 105 reads the stored packets directly from the input FIFO buffers 103.

In a preferred embodiment of the present invention, the input FIFO buffer 103 is programmed and monitored by the MCU 105, through the control bus 109.

The SDC 104 is responsible for communicating with an external memory device or devices. In a preferred embodiment of the present invention, the SDC 104 comprises an entire memory controller and an associated PHY (Physical layer of OSI Reference Model), and interfaces directly to memory devices such as DDR memory, flash memory, and so on.

The MCU 105 is a micro-controller, comprising a pipelined controller, one or more arithmetic-logic units, one or more register files, one or more instruction and data memories, and additional components. The instruction set of the MCU 105 is designed for multi-stream parsing.

The Host/Switch interface 106 preferably provides a secure connection between the MCU 105 and external devices.

The external devices include, by way of a non-limiting example, an external hard-disk, an external DVD, a high density (HD)-DVD, a Blu-Ray disk, electronic appliances, and so on

The Host/Switch interface 106 also preferably supports connections to a home networking system, such as, by way of non-limiting examples, Multimedia over Coax Alliance (MOCA) connections, phone lines, power lines, and so on.

The Host/Switch interface 106 supports glueless connectivity to a variety of industry standard Host/Switch inputs/outputs 122. The industry standard Host/Switch inputs/outputs 122 include, by way of a non-limiting example, a Universal Serial Bus (USB), a peripheral component interconnect (PCI) bus, a PCI-express bus, an IEEE-1394 Firewire bus, an Ethernet bus, a Giga-Ethernet (MII, GMII bus), an advanced technology attachment (ATA), a serial ATA (SATA), an integrated drive electronics (IDE), and so on.

The Host/Switch interface 106 also preferably supports a number of low speed peripheral interfaces such as universal asynchronous receiver/transmitter (UART), Integrated-Integrated Circuit (12C), IrDA, Infra Red (IR), SPI/SSI, Smartcard, modem, and so on.

In a preferred embodiment of the present invention, the Host/Switch interface 106 is in form of a socket of, and connects to, a central switch as described in U.S. patent application Ser. No. 11/603,199 of Morad et al.

The output FIFO buffer 107 serves for storage of a multiplexed transport/program stream which is generated and formed into packets by the MCU 105. The MCU 105 stores the multiplexed transport/program stream directly into the output FIFO buffer 107.

In a preferred embodiment of the present invention, the output FIFO buffer 107 is programmed and monitored by the MCU 105, via the control bus 109.

The DVB-Tx 108 units serve for reading stored packets from the output FIFO buffer 107, in the order in which the stored packets were received by the output FIFO buffer 107, and transmitting the packets via the DVB-out outputs 123.

The DVB-Tx 108 units preferably format the stored packets into a plurality of transmission standards. By way of a non-limiting example, some of the standards are serial or parallel DVB.

A preferred embodiment of the present invention comprises two serial DVB-out interfaces 123 and two parallel DVB-out interfaces 123 for each DVB-Tx 108 unit.

Persons skilled in the art will appreciate that multiplexers are typically concerned with outputting a substantially constant data rate. To that end, multiplexers typically add null packets at the output, to compensate for non-constant output data rate.

In a preferred embodiment of the present invention, the MCU 105 inserts null packets, when needed, into the output FIFO buffers 107.

Typical operation of the stream multiplexer/de-multiplexer 100 of FIG. 1, in multiplexing mode, is now described.

In a preferred embodiment of the present invention, the MCU 105 inputs one or more bit-streams, from one or more sources.

The bit-streams comprise, by way of a non-limiting example, video, audio, still image, data, and other types of media bit-streams.

The one or more sources comprise: an external memory device, via the SDC 104; an external host, via the Host/Switch interface 106 unit; and the input FIFO buffers 103.

The MCU 105 packetizes the bit-streams, and multiplexes the bit-streams into one or more packetized multiplexed streams.

In a preferred embodiment of the present invention, the MCU 105 produces packet headers and assigns timestamps automatically.

In another preferred embodiment of the present invention, the MCU 105 inputs timestamps, and additional data associated with the bit-streams, from the one or more sources of bit-stream data. The additional data includes, by way of a non-limiting example, tagging and indexing tables associated with the bit-streams.

The packetizing and multiplexing is performed according to a variety of system standards, including, by way of a non-limiting but typical example, MPEG2, MPEG4, and DV. The MCU 105 enables changing system standards and multiplexing parameters by programming.

The MCU 105 unit multiplexes a plurality of input bit-streams into a single packetized multiplexed stream, or a plurality of packetized multiplexed streams, as needed.

The packetized multiplexed stream or streams produced by the MCO 105 are typically stored into one or more output FIFO buffers 107.

A preferred embodiment of the present invention also stores the packetized multiplexed stream or streams on external memory via the SDC 104, or on an external device via the Host/Switch interface 106.

Typical operation of the stream multiplexer/de-multiplexer 100 of FIG. 1, in de-multiplexing mode, is now described.

In a preferred embodiment of the present invention, the stream multiplexer/de-multiplexer 100 inputs one or more bit-streams, from one or more sources.

The bit-streams are comprised, by way of a non-limiting example, of transport streams, program streams, and similar type streams, comprising, by way of a non-limiting example, multi-channel audio, video and data.

The one or more sources comprise: an external memory device, via the SDC 104; an external host, via the Host/Switch interface 106 unit; and the one or more DVB-in inputs 120 via the DVB-Rx 101 units.

If an input bit-stream requires validation, the input bit-stream is routed through the DVB-Rx 101 units.

If an input bit-stream requires filtering according to PIDs comprised in the bit-stream, one or more of the PID filters 102 filters the bit-stream, produces indication values and routes the indication values to a suitable input FIFO buffer 103, thereby indicating to the input FIFO buffer 103 whether packets associated with the indication values are to be stored in the input FIFO buffer 103 or not.

The MCU 105 reads a validated and filtered bit-stream from one or more input FIFO buffers 103, and processes the bit-streams in accordance with a variety of system multiplexing standards. Such processing is, by way of a non-limiting example, indexing the stream, removing headers from the stream, separating the stream into a plurality of audio, video and data packets, recording Program Clock References (PCRs) associated with the stream, and so on.

It is to be appreciated that a bit-stream may be input into the stream multiplexer/de-multiplexer 100 by other routes, such as from the memory input/output interface 121 via the SDC 104, and from the Host/Switch input/output 122 via the Host/Switch interface 106. In such cases the MCU 105 may additionally process the bit-stream, performing functions typically assigned to the DVB-Rx 101 units and to the PID filter 102 units, such as, by way of a non-limiting example, to check the stream validity, and to filter for a specific stream.

The processed bit-stream data, along with associated process data is output to external devices. The external devices comprise an external memory, accessed via the SDC 104, and an external device accessed via the Host/Switch interface 106.

It is to be appreciated that the MCU 105 preferably monitors, provides controls signals, and schedules other components within the stream multiplexer/de-multiplexer 100, as appropriate, via the control bus 109.

It is to be appreciated that a preferred embodiment of the present invention supports simultaneous multiplexing and de-multiplexing. In one preferred embodiment of the present invention, the stream multiplexer/de-multiplexer 100 supports de-multiplexing 7 different input multiplexed streams and multiplexing 2 independent output streams

It is to be appreciated that the multiplexed streams are received from DVB-In input 120 or from Host/Switch input/output 122, using a variety of communication standards. In a preferred embodiment of the present invention the DVB-In input 120 takes the form of a multi-stream DVB interface, either serial, or parallel.

The PID filters 102 will now be described in more detail.

In one preferred embodiment of the present invention, each PID filter 102 can be configured with up to 32 different PID values for use in PID comparison.

In a preferred embodiment of the present invention, the PID Filter 102 can use a single configured PID value for indicating output of 2, 4, or 8 data streams having consecutive PIDs. Filtering a set of data streams with consecutive PIDs is achieved by comparing only most significant bits from the packet PIDs and the PID filter 102 configuration PID value. By way of a non-limiting example, the filtering of a set of data streams with consecutive PIDs is done by reading a value of a PID from the packet header, right shifting the value of the PID by 0, 1, 2, or 3 bits, and comparing with the configured PID value which has been right shifted by the same number of bits.

By way of a non-limiting example, if PIDs 1100, 1101, 1110, and 1111 (binary representation) are all supposed to be stored, then a single PID value configured in the PID filter 102 can be used, in conjunction with right shifting by two bits, to cause an indication that the four PID values are to be stored. Since the 2 lower bits do not affect the filtering result, for the above mentioned PID values the PID filter 102 is configured with a value of 1100 (binary representation), and the right shift is set to 2 bits. Every PID value entering the PID filter 102 is right shifted by 2 bits, and compared with the configured PID value, which is also right shifted by two bits. The desired data stream PID values, when right shifted by two bits, all produce a value of 0011. The configured PID filter value of 1100, when right shifted by two bits, also produces the value of 0011. Thus, all the desired data streams pass the filter.

It is to be appreciated that when the shift mechanism is set to N bits, the number of filtered PIDs is multiplied by 2^{N}.

By way of another non-limiting example, the PID filter 102 can be configured to pass 128 different data streams with 128 different PIDs, provided that the PIDs are in groups of at least 4 consecutive values. Instead of filtering 32 PIDs, the PID filter 102 can now filter 32*2^{N}, where N is the number of bits for right shifting. For the present example, N=2.

It is to be appreciated that the right shifting feature of the PID filter 102 design enables one hardware PID filter to do a job of several hardware PID filters, thereby providing a saving in the number of hardware PID filters in the stream multiplexer/de-multiplexer 100.

The SDC 104 is now described in more detail.

In a preferred embodiment of the present invention, data transfer between the stream multiplexer/de-multiplexer 100, and an external, secure, memory input/output interface 121 is via the SDC 104. The internal units of the stream multiplexer/de-multiplexer 100 may transfer data, preferably simultaneously, to and from the SDC 104, preferably using request commands to deal with different in/out FIFO buffers (not shown) or direct memory access modules. Preferably, the request commands can be issued simultaneously. The SDC 104 manages a queue of data requests and memory accesses, and a queue of priorities assigned to each access request, manages memory communication protocol, automatically allocates memory space and bandwidth and comprises hardware dedicated to providing priority and quality of service.

Preferably, the SDC 104 is a secure SDC, designed to encrypt and decrypt data in accordance to a variety of encryption schemes. Each memory address preferably has a different secret key assigned to it, and the secret keys are not constant, but vary based on certain information kept in a secure one time programmable (OTP) memory, as well as information received from external security devices such as Smartcards, and yet other information received from on-chip True Random Number Generator and the like.

In yet another preferred embodiment of the invention, the SDC Controller 104 can take the form of a socket of, and connect to a Secured Memory Controller, as described in U.S. patent application Ser. No. 11/603,199 of Morad et al.

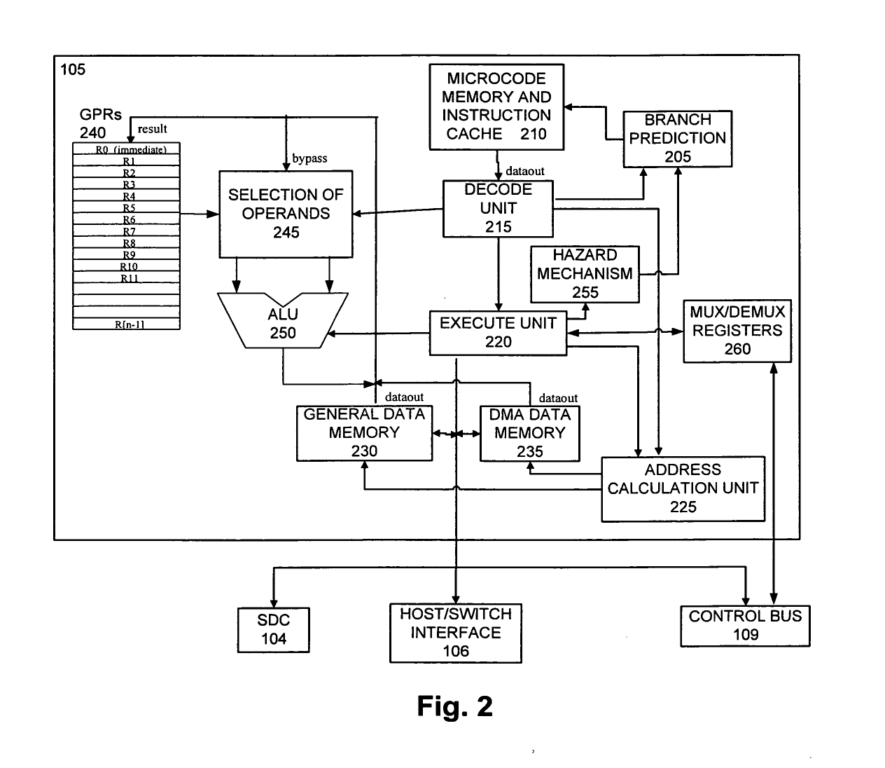

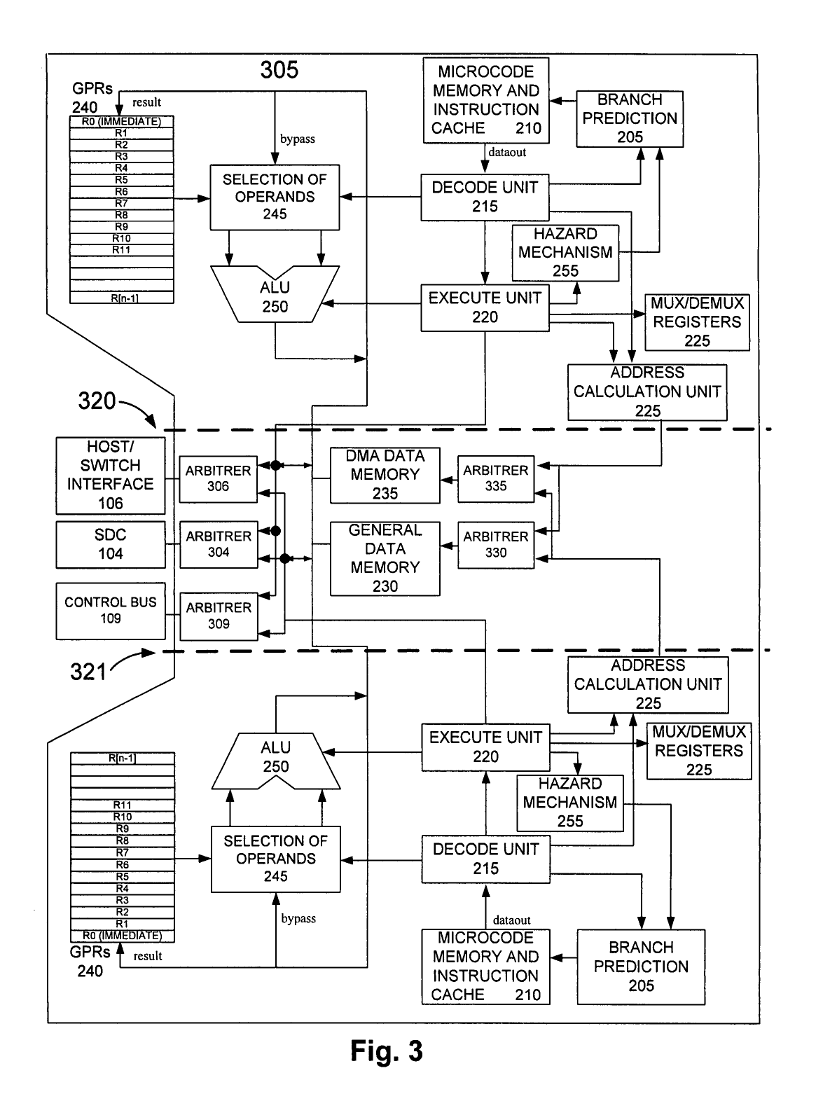

It is to be appreciated that the stream multiplexer/de-multiplexer 100 comprises separate multiplexing and de-multiplexing data flows. The MCU 105 is operatively connected to both the multiplexing data flow and the de-multiplexing data flow. A speedy and efficient MCU 105 as described below, and described additionally with respect to FIG. 2 and FIG. 3, enables the stream multiplexer/de-multiplexer 100 to perform simultaneous multiplexing and de-multiplexing, and even de-multiplex more than one input stream and multiplex more than one output stream simultaneously.

A preferred embodiment of the present invention de-multiplexes seven input streams and multiplexes two output streams simultaneously.

In a preferred embodiment of the present invention, the MCU 105 processor is constructed with a unique Reduced Instruction Set Computer (RISC) architecture which comprises hardware based instructions as described below, some of which are additionally supported by hardware based accelerators:

The MCU 105 will now be described in more detail.

The MCU 105 preferably comprises the following instruction set:

TABLE 1
MCU 105 opcodes

| OPCODE OR | |
|---|---|
| OPCODE | |
| GROUP | DESCRIPTION OF OPCODE AND COMMENTS |
| Load dedicated | Load a value from a dedicated mux/demux register |
| | (described in more detail below, with reference to FIG. 2 |
| | and FIG. 3). |
| Store dedicated | Store a value into a dedicated mux/demux register. |
| Add | Add contents of 2 general purpose registers (GPRs). |
| | Uses the following flags: use carry, use saturation, shift |
| | right 1 bit. |
| Subtract | Subtract contents of 2 GPRs. Uses the following flags: |
| | use carry, use saturation, shift right 1 bit. |
| Logic | A group of opcodes for performing logic operations on |
| operations | contents of one or two GPRs (depending on the logic |
| | operation). The logic operations are: AND, OR, |
| | FIND_MSB, XOR, SHIFT_RIGHT, SHIFT_LEFT. |
| Arithmetic | A group of opcodes for performing arithmetic operations |
| operations | on contents of a GPR. The arithmetic operations are: |
| | SHIFT_RIGHT, ABS. |
| Insert | Insert a value from GPR into a specified location in |
| | another GPR. |
| Extract | Extract a value from a specified location of one GPR into |
| | another GPR. |
| Multiply | Multiply contents of two GPRs. Typically produces a |
| | 64-bit result. If each GPR is 32-bits, the 64-bit result is |
| | stored in two GPRs. |
| Load | Load an immediate field into a GPR. An immediate field |
| immediate | is a field in an instruction which comprises data, and not |
| | an address of where the data resides. |
| Load 4 bytes | Load one 32-bit word from general data memory. |
| | Options: the address of the word can come from a GPR, |
| | from an immediate field, and via an indirect pointer. |
| Store 4 bytes | Store one 32-bit word in general data memory. |
| | Options: the address of the word can come from a GPR, |
| | from an immediate field, and via an indirect pointer. |
| Load 8 bytes | Load one 64-bit word from DMA data memory. |
| | Options: the address of the word can come from a GPR, |
| | from an immediate field, and via an indirect pointer. |
| Store 8 bytes | Store one 64-bit word in DMA data memory. |
| | Options: the address of the word can come from a GPR, |
| | from an immediate field, and via an indirect pointer. |
| Branch | Compare contents of two GPRs. If a specified condition |
| | is satisfied, change a program counter (not shown) to |
| | point to a jump address. |
| | Conditions which may be specified: equal, not equal, less |
| | than, less than or equal, greater than, greater than or |
| | equal. |
| Call | Call a routine. The program counter (not shown) is saved |
| | in a multi-level stack. |
| Return | Return from a routine. The program counter (not shown) |
| | is restored from the multi-level stack. |
| Interface | A group of opcodes comprising: |
| activation | activate a DMA interface and issue a request to the |
| | SDC 104; |
| | activate the Host/Switch interface 106 and issue a |
| | single request as master to Host/Switch Input/output 122; |
| | and |
| | activate the Host/Switch interface 106 and issue a |
| | pipe request as master to Host/Switch Input/output 122. |
| Divider | Activate the multi-cycle divider to perform long division |
| activation | using data from three GPRs and store a result in a fourth |
| | GPR. The division nominator is a concatenation of |
| | values in two of the three GPRs, providing double |
| | precision, and the division denominator is a value of the |
| | third GPR. |
| Nop | No operation. |

Reference is now made to FIG. 2, which is a simplified functional diagram of a Micro Controller Unit (MCU) 105 constructed and operative in accordance with a preferred embodiment of the stream multiplexer/de-multiplexer of FIG. 1. The MCU 105 incorporates elements of RISC architecture, together with unique hardware units designed to accelerate certain tasks.

To improve performance of the MCU 105, each instruction comprises a field for prediction of a next address to be read from an instruction cache, thereby enabling software branch prediction. The MCU 105 comprises a branch prediction unit 205, to perform the software branch prediction.

To further improve the MCU 105 performance and to reduce hardware cost, the MCU 105 comprises a microcode memory and instruction cache 210.

Caching instructions, in addition to improving performance and reducing hardware cost, enables the MCU 105 to access lengthier than normal microcode, in order, by way of a non-limiting example, to support multi-standard multiplexing which may require lengthy code space.

Caching data, in addition to improving performance and reducing hardware cost, enables the MCU 105 to access larger than normal data structures, in order, by way of a non-limiting example, to support multi-standard multiplexing which may require large data storage space.

The MCU 105 is a pipelined processor, having at least three processing stages. By way of a non-limiting example, the three processing stages are: fetch, decode, and execute.

Preferably, in each MCU 105 computing cycle, the branch prediction unit 205 provides an address of a next instruction to the microcode memory and instruction cache 210. The next instruction is usually already in the microcode memory and instruction cache 210. If the next instruction is not in the microcode memory and instruction cache 210, the microcode memory and instruction cache 210 fetches the next instruction via the SDC 104 unit from an external memory (not shown). It is to be appreciated that typically, the microcode memory and instruction cache 210 is loaded with instructions, by an external host (not shown), before the stream multiplexer/de-multiplexer 100 starts operation, so the microcode memory and instruction cache 210 typically starts operation with instructions already loaded.

The MCU 105 processes the next instruction in accordance with the three stages, which are further described below.

In the fetch stage, the instruction that was fetched from the microcode memory to the microcode memory and instruction cache 210 is parsed, fields comprised in the instruction are extracted, and written into pipe registers (not shown) to be passed to the decode unit 215.

The operation of the decode stage will now be described.

An MCU 105 instruction typically comprises a field or fields containing IDs of General Purpose Registers (GPRs). The GPRs comprise source GPRs with values of operands, and destination GPRs, for storing a result of executing the instruction. The decode unit 215 reads each field, and stores values from the operand GPRs into pipe registers (not shown), to be passed to the execute stage.

By way of a non-limiting example, each instruction has 4 bits of operation code (opcode), between one and four GPR ID fields, immediate operand fields, and flag fields. The GPR ID fields indicate the source GPRs and the destination GPRs. The length of each field in the instruction is preferably flexible, according to field lengths required by different instructions. By way of a non-limiting example, each of the GPR ID fields is 4 bits long.

The decode unit tentatively executes the instruction, preferably providing a result of executing the instruction no later than at a beginning of the execute stage. Computations involving multi-cycle instructions, such as, by way of a non-limiting example, multiply and load instructions, are thereby started by the decode unit at the decode stage.

If an instruction for loading data from memory is decoded by the decode unit 215, an address from which the load is to be performed is calculated by an address calculation unit 225, and a read-from-memory signal is raised. The address calculation unit 225 is operatively connected to two memories, a general data memory 230, and a Direct Memory Access (DMA) data memory 235. An appropriate one of the data memories returns data on the next cycle, when the instruction is at the execute stage. The data is then loaded from memory and written into an appropriate GPR in a GPR file 240.

There are preferably two types of memory in the MCU 105. One type of memory is the general data memory 230, used for storing temporary variables and data structures, and a second type of memory is the DMA data memory 235, used for storing data arriving from, and intended for transfer to, the SDC 104.

The values from the appropriate source GPRs is also inserted, via a selection of operands unit 245, as inputs to a two-stage multiplier in an ALU 250, for the use in case of a multiply instruction. In case of a multiply instruction, a result for output will be ready on the next cycle, when the instruction is at the execute stage.

The number of registers in the GPR file 240 comprises, by way of a non-limiting example, 16 GPRs, enumerating R0 to R15, each of the GPRs preferably having 32 bits. The GPRs are used for temporary data storage during basic instruction execution.

In case of a branch instruction, a call instruction, and a return instruction, the decode unit 215 loads operands into the selection of operands unit 245, and the ALU 250 performs any comparison, if a comparison is needed. If a specified condition comprised in the comparison is satisfied, a microcode memory address is replaced with an appropriate address according to the instruction. Otherwise, the microcode memory address is simply increased by 1. Operation of the comparison instructions ends at the decode stage, and does not affect other logic or registers at the execute stage.

The execute stage operation will now be described.

Data stored during the decode stage is used for performing logic and arithmetic operations in the ALU 250. The actual operation of the execute stage depends on the opcode in the instruction.

If an opcode is an add opcode, a subtract opcode, a logic operation opcode, an insert opcode, an extract opcode, a multiply opcode, or a load immediate opcode, an output of the ALU 250 is stored into a destination GPR which is specified in the instruction comprising the opcode.

If an opcode is load 4 bytes, or load 8 bytes, data from data memories which are specified in fields in the instruction comprising the opcode is stored into a destination register also specified in the instruction.

If an opcode is store 4 bytes, or store 8 bytes, the address, data and write request signal are issued to a data memory as specified by the address.

If an opcode is an interface activation, then a request is issued to one of the interfaces 104 106.

If an opcode is a divide activation, then a request comprising source and destination GPR addresses is issued to a hardware divider.

In a preferred embodiment of the present invention, the architecture of the processor includes a hardware hazard mechanism 255 and a hardware bypass mechanism.

The hazard mechanism 255 is designed to resolve data contention when one of the following instructions: multiply, load, branch, call, and return, uses a GPR at the decode stage, while at the same time another instruction which is at the execute stage modifies content of the same GPR. The hazard mechanism continuously compares a destination field, or destination fields, of a current execute stage instruction to a source field or source fields of a current decode stage instruction. If there is a match, that is, one or more of the execute stage destination fields coincides with one or more of the decode stage source fields, a hardware bubble is inserted between the decode stage instruction and the execute stage instruction. The hardware bubble is a Nop instruction, inserted automatically by the hazard mechanism 255. The decode stage instruction will thus stay for one more cycle in the decode stage, while the execute stage instruction is performed. This operation is similar to microcode having a software Nop opcode, but is performed automatically by the hazard mechanism 255. The operation affects the MCU 105 performance, but doesn't occupy space in microcode memory.

The bypass mechanism (not shown) is designed to resolve data contention when an instruction at the decode stage is not one of the following instructions: multiply, load, branch, call or return. In this case, a hazard does not occur. However, during the decode stage, source fields are translated into GPR contents, for the contents to be modified later, at the execute stage. In such cases, a result of a current execute stage, stored into a GPR, may collide with decode stage data. The bypass mechanism continuously compares destination fields of the execute stage instruction to source fields of the decode stage instruction. If one or more of the execute destination fields coincides with one or more of the decode source fields, the decode unit 215 bypasses the content of the decode source field and uses the result of the current execute stage. Since many instructions depend on results of previous instructions, an alternative to the bypass mechanism would be a no-operation instruction. The bypass mechanism prevents such “dead” cycles and significantly improves performance of the MCU 105.

The MCU 105 unit deals automatically, using hardware, with stream alignment, and with cases such as when a bit-stream buffer is empty and full. The bit-stream buffer can be, by way of a non-limiting example, the input FIFO buffers 103, the output FIFO buffer 107, and external memory interfaced via the SDC 104. One or more dedicated mux/demux registers 260 are connected to the execute stage 220, and to the control bus 109, in order to ensure stream alignment, and resolve cases such as bit-stream buffer empty and bit-stream buffer full. The dedicated mux/demux registers 260 comprise pointer registers, which point to a next position from which data is to be read from a bit-stream buffer, and to a next position to which data is to be written in the bit-stream buffer. The dedicated mux/demux registers 260 are configured so that whenever the bit-stream buffer is empty or full, a request is issued to the SDC 104 for reading or writing data via the memory input/output interface 121.

The use of the one or more dedicated mux/demux registers 260 in ensuring stream alignment will be additionally described below with reference to unique instructions, named put-bits and get-bits, which are preferably implemented in the MCU 105 instruction set.

In preferred embodiments of the present invention, the MCU 105 includes one or more hardware accelerator units as described below.

In a preferred embodiment of the present invention, microcode memory as typically used in standard microprocessors is replaced by a microcode memory and instruction cache 210. The microcode memory and instruction cache 210 is preferably 64 bits wide, thus enabling storage of longer programs. The virtual space of the cache is mapped into an area of an external memory. In such an embodiment, address selection in branch instructions is made during the decode stage, and is sampled and issued to the microcode memory and instruction cache 210 only at the execute stage.

In another preferred embodiment of the present invention, in addition to the general data memory 230 and the DMA data memory 235, one or more additional data caches (not shown) are implemented for storage of larger data arrays and buffers. The one or more data caches are preferably 32 bits wide. For accessing the one or more additional data caches, an additional specific instruction is implemented. The opcode of the additional specific instruction is load/store data cache. An address for the data cache is calculated during the decode stage and passed to the execute stage. Both load and store instructions issue the stored address during the execute stage. The three stages in a pipeline described above with respect to FIG. 2, fetch, decode, and execute, are preferably four stages instead of the three described, since the additional specific instruction uses an additional execute stage for receiving data from the additional data caches (not shown) and sampling the data into an appropriate GPR.

In yet another preferred embodiment of the present invention, the MCU 105 has several data caches, by way of a non-limiting example two data caches, which can be accessed simultaneously for parallel loads and parallel stores.

In another preferred embodiment of the present invention, the MCU 105 has one or more additional load/store instructions for accessing other data memories, in addition to the general data memory 230 and the DMA data memory 235. The additional load/store instructions operate similarly to the load/store 4/8 byte instructions.

In yet another preferred embodiment of the present invention, described in more detail below with reference to FIG. 3, the MCU 105 is enhanced by implementing support for a multi-instruction, preferably dual instruction, acceleration. The support enables multi-consecutive independent instructions to be united into a single instruction during compilation. The ALU 250 is duplicated, so that multi arithmetic and logic instructions can be carried out simultaneously. The general data memory 230 and the DMA data memory 235 are split into banks, so that, preferably, two load and store instructions can simultaneously access memory at two different addresses, each of the two different addresses belonging to a different bank. The hazard and bypass mechanisms are preferably extended so that all possible dependencies are checked. In the following example, four options need to be checked in order to prevent contention in performing two simultaneous instructions:
1. Comparison of decode stage instruction source fields of a first instruction with the execute stage instruction destination fields of the first instruction.
2. Comparison of decode stage instruction source fields of the first instruction with the execute stage instruction destination fields of a second instruction.
3. Comparison of decode stage instruction source fields of the second instruction with the execute stage instruction destination fields of the first instruction.
4. Comparison of decode stage instruction source fields of the second instruction with the execute stage instruction destination fields of the second instruction.

In another preferred embodiment of the present invention, the MCU 105 comprises several processors with shared resources. Persons skilled in the art will appreciate that in such an embodiment, the MCU 105 is a super-scalar multi-processor.

Reference is now made to FIG. 3 which is a simplified functional diagram of a Micro Controller Unit (MCU) 305 constructed and operative in accordance with an alternative preferred embodiment of the stream multiplexer/de-multiplexer of FIG. 1. The MCU 305 is constructed according to a multi-processor architecture.

By way of a non-limiting example, the MCU 305 comprises two processors, preferably integrated in a single integrated circuit.

A first processor preferably comprises components similar to components described with reference to FIG. 2, which are similarly operatively connected. The components are a branch prediction 205 unit, a microcode memory and instruction cache 210, a decode unit 215, an execute unit 220, an address calculation unit 225, a GPR file 240, a selection of operands unit 245, and an ALU 250. The components of the first processor are depicted above dashed line 320 of FIG. 3.

A second processor preferably comprises components similar to components described with reference to FIG. 2, which are similarly operatively connected. The components are a branch prediction 205 unit, a microcode memory and instruction cache 210, a decode unit 215, an execute unit 220, an address calculation unit 225, a GPR file 240, a selection of operands unit 245, and an ALU 250. The components of the second processor are depicted below dashed line 321 of FIG. 3.

The first processor and the second processor share a general data memory 230, a DMA data memory 235, a SDC 104, a Host/Switch interface 106, and a control bus 109.

In order to share the general data memory 230, an arbitrer 330 is placed at an input of the general data memory 230, for handling cases of simultaneous requests to the general data memory 230.

In order to share the DMA data memory 235, an arbitrer 335 is placed at an input of the DMA data memory 235, for handling cases of simultaneous requests to the DMA data memory 235.

In order to share the SDC 104, an arbitrer 304 is placed at an input of the SDC 104, for handling cases of simultaneous requests to the SDC 104.

In order to share the Host/Switch interface 106, an arbitrer 306 is placed at an input of the Host/Switch interface 106, for handling cases of simultaneous requests to the Host/Switch interface 106.

In order to share the control bus 109, an arbitrer 309 is placed at an input of the control bus 109, for handling cases of simultaneous requests to the control bus 109.

It is to be appreciated that the arbitrers 304, 306, 309, 330, 335 typically perform as follows: if there is no contention, the arbitrers 304, 306, 309, 330, 335 forward requests and commands to input of units for which the arbitrers 304, 306, 309, 330, 335 perform arbitration. If there is contention, caused by two requests or commands arriving at a unit simultaneously, or by a request or a command arriving while the unit is busy, the arbitrers return a signal to the MCU which needs to wait, and the MCU uses the hardware hazard mechanism 255. The hazard mechanism 255 blocks execution of an instruction in the MCU which needs to wait, for one cycle, after which the MCU re-sends the request or command, repeating the above until the MCU succeeds.

The processors within the MCU 305 communicate and synchronize their operations using various synchronization techniques such as semaphores or special flag registers. Since each processor has an independent microcode memory and instruction cache 210, ALU 250, and GPR file 240, the number of instructions carried out simultaneously can equal the number of processors. The multi-processor architecture is used when performance requirements can not be satisfied by a single processor.

Additional enhancements to the present invention are described below.

In a preferred embodiment of the present invention several narrow registers, by way of a non-limiting example, 8-bit wide registers, can be dynamically configured into one larger register. By way of a non-limiting example, nine 8-bit registers can be dynamically configured into one long 72 bit accumulator.

In a preferred embodiment of the present invention, one or more automatic step registers (not shown) are implemented, designed to automatically increase/decrease step values stored in a GPR used in load/store/branch operations. Preferably several, by way of a non-limiting example two, step values are concatenated and stored in each of the step registers. Operation of a step register mechanism is illustrated by the following non-limiting example. Given a microcode loop containing a load instruction, the load instruction uses a GPR as a pointer to memory, that is, the GPR contains a memory address. The memory address is to be incremented at each iteration of the microcode loop by a given value. The step register mechanism configures an automatic step register with the given value, so that each time the load instruction occurs, the GPR containing the memory address is incremented by the given value. The automatic step register mechanism removes a need for explicit calculation of a next address in microcode, and significantly improves performance of the MCU 105.

It is to be appreciated that features described with reference to the MCU 105 throughout the present specification are to be understood as referring also to the MCU 305.

In preferred embodiments of the present invention, additional instructions are implemented to further improve the MCU 105 performance. Depending on an intended use for an implementation of the present invention, one of the additional instructions, or several of the additional instruction in combination may be provided in the implementation. The additional instructions are:

A multiply-and-accumulate instruction: a multi-cycle instruction, which multiplies contents of 2 GPRs, and accumulates a result of the multiplication in an accumulator. By way of a non-limiting example, the multiply-and-accumulate instruction multiplies contents stored in two 64-bit GPRs and stores a result in a 72-bit accumulator. To support the multiply-and-accumulate instruction, the fetch, decode, and execute stages are extended by adding a pre-decode stage and a second execute stage, in order to improve efficiency. Hazard and bypass mechanisms are extended to address possible data contentions between the new stages.

A concatenate-and-accumulate instruction: a single cycle instruction, which concatenates contents of 2 GPRs, and accumulates the concatenated result in an accumulator. By way of a non-limiting example, the concatenate-and-accumulate instruction concatenates contents of two 32-bit GPRs into a 64-bit result, and accumulates the result in a 72-bit accumulator.

A bit-reverse instruction: a single cycle instruction, which reverses a bit order of the lowest N bits of a first GPR, and stores a result in a second GPR. It is to be appreciated that the value of N may be in an immediate field, and the value of N may be in a third GPR. It is also to be appreciated that the first GPR and the second GPR can be the same, thereby performing in-place bit-reversal.

A multiply-and-shift instruction: a multi-cycle instruction, which multiplies contents of 2 GPRs, shifts the result right by a number of bits specified in another GPR, and stores the lowest M bits, by way of a non-limiting example, the lowest 32 bits, of the right-shifted result in a GPR.

A put-bits instruction and a get-bits instruction: preferably single cycle instructions. The put-bits instruction puts P bits from a GPR to a bit-stream buffer. The get-bits instruction gets P bits from a bit-stream buffer to a GPR. The bit-stream buffer may be, by way of a non-limiting example, in external memory accessed via the memory interface 121 of FIG. 1, the input FIFO buffer 103 of FIG. 1, and the output FIFO buffer 107 of FIG. 1. The dedicated mux/demux registers 260 comprise pointer registers, which advance whenever data is written into and read from the bit-stream buffer. The pointer registers always points to a next position to be written into and read from in the bit-stream buffer. The register pointers are incremented by a value of P in performing each put-bits and get-bits instruction, P being typically comprised in an immediate field in the put-bits and get-bits instructions. Maintaining the pointer registers ensures correct stream alignment for read and write operations.

A branch Host/Switch instruction: an instruction that behaves similarly to a regular branch instruction, but instead of comparing values stored in GPRs, compares a value of a register obtained via the Host/Switch interface 106, with an immediate value, and updates a jump address if the comparison condition is satisfied. The register whose value was obtained via the Host/Switch interface 106 is one of the dedicated mux/demux registers 260.

A cyclic-left-shift instruction: a single cycle instruction which performs a cyclic left shift on contents of a GPR, and stores the result in a GPR. Such a shift may be a cyclic shift of an entire data word, or a cyclic shift of N bits of a K-th group of bits, by way of a non-limiting example cyclic-left-shifting eight bits of each byte of a value stored in the GPR.

A median instruction: a single cycle instruction which returns a median value of contents of several, by way of a non-limiting example three, GPRs, and stores a result in a GPR. It is to be appreciated that the median instruction comprises a field for each GPR with a value for which the median value is to be calculated, and a field for a GPR where the result is to be stored.

A controller instruction: a single cycle instruction designed to control special purpose hardware units. The parameters and control signals may be included in immediate fields of the instruction.

Swap instruction—a single cycle instruction which swaps locations of groups of bits, by way of a non-limiting example, swapping bytes, which are groups of 8 bits, of a GPR, and stores a result in a GPR. Byway of a non-limiting example, the swap instruction can be used to swap bytes 3, 2, 1, 0 and store as bytes 0, 1, 2, 3. The swap order can be defined by a value in an immediate field, and the swap order can be defined by an address of a GPR which contains the value defining the swap order.

A load-filter-store instruction: an instruction designed to speed-up linear filtering, by way of a non-limiting example convolution, operations. The load-filter-store instruction simultaneously loads more than one data word from several different memories, performs a filtering operation on data words loaded in a previous cycle, and stores results of the filtering operation performed in the previous cycle into memory. By way of a non-limiting example, the load-filter-store instruction simultaneously loads two data words and two filter coefficients from two different memories, performs a filtering operation on two data words which were loaded in a previous cycle, and stores two filtered data words, which are results of the filtering operation performed in the previous cycle, into two different memories. It is to be appreciated that the filtering operation is typically a convolution operation. It is to be appreciated that the load-filter-store instruction is an instruction for performing a pipelined linear filtering operation. While the load-filter-store operation does take longer than one cycle to complete, once the pipelined linear filtering operation is in operation, the operation inputs and outputs data once per computing cycle, thereby providing a throughput substantially similar to the throughput of a one cycle instruction.

A clip-N-K instruction: a single cycle instruction which clips a value contained in specific bits in a GPR into a range of values from N through K, and stores a result in a GPR. By way of a non-limiting example, the clip-N-K instruction clips the value into a range between 30 and 334.

A compare-PID instruction: a single cycle instruction which compares a certain data word with several different pre-configured values. By way of a non-limiting example, the compare-PID instruction may compare, within one cycle, a value of a data word comprising a PID value, with 16 pre-configured PID values.

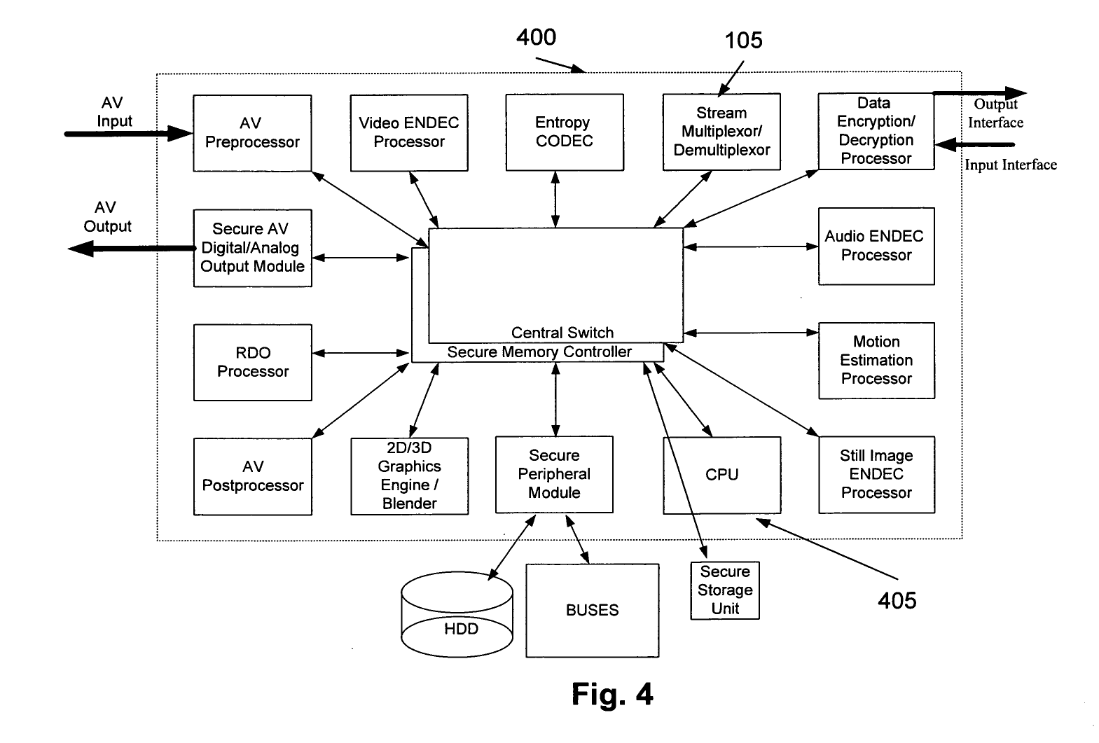

A non-limiting practical application of the stream multiplexer/de-multiplexer 100 is in conjunction with a media codec device, such as described in U.S. patent application Ser. No. 11/603,199 of Morad et al. Reference is now made to FIG. 4, which is a simplified functional diagram of a non-limiting example of a practical use for the stream multiplexer/de-multiplexer 100 of FIG. 1.

FIG. 4 depicts the stream multiplexer/de-multiplexer 100 of FIG. 1 in context of a media codec device 400. The media codec device 400 is described in U.S. patent application Ser. No. 11/603,199 of Morad et al. The media codec device 400 receives video, audio, and data streams and performs one or more of the following sequences of actions:

de-multiplex, decrypt, and decode the received data streams in accordance with one or more algorithms, and index, post-process, blend and playback the received data streams;

preprocess, encode in accordance to one or more compression algorithms, multiplex, index and encrypt a plurality of video, audio and data streams;

trans-code, in accordance with one or more compression algorithms, a plurality of video, audio, and data streams into a plurality of video, audio and data streams;

perform a plurality of real-time operating system tasks, via an embedded CPU 405; and

any combination of the above.

It is expected that during the life of this patent many relevant devices and systems will be developed and the scope of the terms herein, particularly of the terms client stations, CPU, blade boards, communication, and frames are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for performing multiplexing and de-multiplexing of packetized digital data streams, comprising:
one or more receivers operative to receive data packets from packetized digital data streams, validate the data packets, and transmit only valid data packets;
one or more PID filters operative to filter packets of the digital data streams according to a Packet ID number comprised in the packets, the PID filters operative to receive valid data packets from the one or more receivers, and to associate a store-or-drop value with each valid data packet;
one or more input First In First Out (FIFO) buffers operative to receive valid data packets from the one or more receivers, to receive the store-or-drop value from the PID filters, and to store digital data based, at least in part, on the store-or-drop value;
an input/output unit operative to transmit the stored digital data from the one or more input FIFO buffers to an external memory and to read digital data from the external memory;
one or more output FIFO buffers operative to receive digital data from the input/output unit and store the digital data; and
one or more transmitters operative to read digital data packets from the output FIFO buffers and to transmit the digital data packets as a packetized digital data stream,
thereby de-multiplexing the packetized digital data streams and multiplexing the packetized digital data streams.

2. Apparatus according to claim 1 and further comprising a unit operative to:
read data from the input FIFO buffers;
write data to the input/output unit;
read data from the input/output unit;
write data to the output FIFO buffers; and
control the receivers, the PID filters, the input FIFO buffers, the input/output unit, the output FIFO buffers, and the transmitters, through a control bus.

3. Apparatus according to claim 2 and wherein the unit is a Micro Controller Unit (MCU).

4. The apparatus according to claim 1 and wherein the multiplexing and the de-multiplexing operate simultaneously.

5. The apparatus according to claim 1 and wherein the packetized digital data streams comprise packetized digital data streams according to more than one digital video standard.

6. The apparatus according to claim 1 and wherein the packetized digital data streams comprise packetized digital data streams according to a DVB standard.

7. The apparatus according to claim 1 and wherein each PID filter is operative to receive packets of digital data from each of the receivers.

8. The apparatus according to claim 1 and wherein each of the input FIFO buffers is operative to receive to receive the store-or-drop values from each of the filters.

9. Apparatus for filtering digital data packets of a digital data stream comprising digital data packets with Packet IDs (PIDS), comprising:
an input unit for receiving a digital data packet;
a PID reading unit for reading a PID comprised in the digital data packet, the PID being comprised of N bits;
a comparator for comparing M most-significant bits of the PID, where M<N, to M most-significant bits of a reference number, thereby producing a result; and
an output unit for sending an output based, at least partly, on the result.

10. The apparatus according to claim 9, and wherein the output comprises the digital data packet.

11. The apparatus according to claim 9, and wherein the comparing is performed between the M most-significant bits of the PID and M most-significant bits of more than one reference number.

12. The apparatus according to claim 11, and wherein the result is based on whether one of the M most-significant bits of the more than one reference number is equal to the M most-significant bits of the PID.

13. The apparatus according to claim 9, and wherein the comparing is performed by:
right-shifting the PID by L bits, where L<M, thereby producing a shifted PID;
right-shifting the reference number by L bits, thereby producing a shifted reference number; and
comparing the shifted PID to the shifted reference number, thereby producing the result.

14. For a digital data stream comprising digital data packets with Packet IDs (PIDS), a method for filtering the digital data packets, comprising, for each packet:
reading the PID comprised in the digital data packet, the PID being comprised of N bits;
comparing M most-significant bits of the PID, where M<N, to M most-significant bits of a reference number, thereby producing a result; and
sending an output based, at least partly, on the result.

15. The filtering method according to claim 14, and wherein the output comprises the digital data packet.

16. A microcontroller operative to perform at least one of the following as a single instruction:
a concatenate-and-accumulate instruction comprising concatenating a value stored in a first general purpose register (GPR) to a value stored in a second GPR, and adding a result of the concatenating to a value in an accumulator;
a bit-reverse instruction comprising reversing a bit order of a lower N bits of a value stored in a first GPR and storing a result of the bit-reverse instruction in a second GPR;
a get-bits instruction comprising reading an M bit value from an address in a buffer external to the microcontroller, the address being comprised in the get-bits instruction, and storing the M bit value in a GPR;
a put-bits instruction comprising reading an M bit value from a GPR, and writing the M bit value in an address in a buffer external to the microcontroller, the address being comprised in the put-bits instruction;
a median instruction comprising computing a median value of more than one general purpose register, and storing the median value in a general purpose register;
a controller instruction for controlling dedicated hardware units external to the microcontroller, the address of which, and the digital control signals to be sent, are included in fields comprised in the controller instruction;
a swap instruction for swapping locations of a number of bits of a general purpose register and storing the result in a general purpose register;
a load-filter-store instruction for loading more than one value from more than one different memory addresses, performing a linear filtering operation, and storing more than one result into more than one different memory addresses;
a clip-N-K instruction for clipping a value comprised in specific bits in a general purpose register into a range of integers from N through K, where N and K are integers, and storing a result of the clipping in a general purpose register; and
a compare-PID instruction for simultaneously comparing a value to more than one other values.

17. The microcontroller according to claim 16 and wherein the value of N in the bit-reverse instruction is comprised in an immediate field in the bit-reverse instruction.

18. The microcontroller according to claim 16 and wherein the value of N in the bit-reverse instruction is comprised in a third GPR.

19. The microcontroller according to claim 16 and wherein the second GPR of the bit-reverse instruction is the same as the first GPR of the bit-reverse instruction, thereby performing in-place bit-reversal.

20. The microcontroller according to claim 16 and wherein the number of bits in the swap instruction is eight, thereby having the swap instruction swap locations of bytes of a general purpose register.

21. The microcontroller according to claim 16, and wherein the load-filter-store instruction is operative to perform a convolution operation.

22. The microcontroller of claim 16 and wherein at least one of the following is performed in a single cycle:
the concatenate-and-accumulate instruction;
the bit-reverse instruction;
the get-bits instruction;
the put-bits instruction;
the median instruction;
the controller instruction;
the swap instruction;
the load-filter-store instruction;
the clip-N-K instruction; and
the compare-PID instruction.

23. The microcontroller of claim 16 and further comprising a special purpose register operative to increment when a get-bits instruction is performed.

24. The microcontroller of claim 16 and further comprising a special purpose register operative to increment when a put-bits instruction is performed.

25. The microcontroller of claim 16 and further comprising one or more special purpose registers operative to detect when the buffer is empty and when the buffer is full.

26. The microcontroller of claim 16 and wherein the micro controller is operative to perform more than one operation in a single cycle, by using more than one microprocessor.

27. The microcontroller of claim 16 and wherein the micro controller is operative to perform more than one operation in a single cycle, by using more than one register bank.

28. The microcontroller of claim 16 and wherein the micro controller is operative to perform more than one operation in a single cycle, by using more than one memory bank.

29. The microcontroller of claim 16 and wherein the micro controller is operative to perform more than one operation in a single cycle, by using more than one Arithmetic Logic Unit (ALU).

30. The microcontroller of claim 16 and wherein more than one register, each of the registers comprised of one or more bits, can be dynamically configured into one register comprising a number of bits equal to the total number of bits in the registers.

31. The microcontroller of claim 16 and further comprising a step register, the step register operative to automatically increment a value in a first general purpose register every time a second general purpose register is accessed.
